(19) United States
(12) Patent Application Publication
(10) Pub. No.: US 2012/0258261 A1
(43) Pub. Date: Oct. 11, 2012

(54) INCREASING ETCH SELECTIVITY OF CARBON FILMS WITH LOWER ABSORPTION CO-EFFICIENT AND STRESS

(75) Inventors: Sirish Reddy, Hillsboro, OR (US); Alice Hollister, Tigard, OR (US); Pramod Subramonium, Beaverton, OR (US); Jon Henri, West Linn, OR (US); Chunhai Ji, Portland, OR (US); Zhi Yuan Fang, West Linn, OR (US)

(73) Assignee: Novellus Systems, Inc., San Jose, CA (US)

(21) Appl. No.: 13/443,668

(22) Filed: Apr. 10, 2012

Related U.S. Application Data
(60) Provisional application No. 61/474,118, filed on Apr. 11, 2011.

(51) Int. Cl. B29B 13/08

(52) U.S. Cl. 427/577; 118/665

(57) ABSTRACT

A method for depositing a film includes arranging a substrate in a plasma enhanced chemical vapor deposition chamber. A first ashable hardmask (AHM) layer that is carbon-based is deposited on the substrate. During the depositing of the first AHM layer, doping is performed with at least one dopant selected from a group consisting of silicon, silane, boron, nitrogen, germanium, carbon, ammonia, and carbon dioxide. An atomic percentage of the at least one dopant is greater than or equal to 5% of the first AHM layer.

### CROSS REFERENCE TO RELATED CASES

This application claims the benefit of U.S. Provisional Application No. 61/474,118, filed on Apr. 11, 2011, which is hereby incorporated by reference in its entirety.

### FIELD

The present disclosure relates to ashable hardmask (AHM) films, and more particularly to systems and methods for depositing carbon-based AHM films.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Ashable hardmask (AHM) films are often used during processing of semiconductor substrates. For example, AHM films may be deposited over an underlying dielectric or poly or conductive layer. The AHM film may be used to control etching of the underlying layer. Later in the process, the AHM film may be stripped using suitable plasma etch ash chemistry.

For traditional AHM films, high transparency (low extinction coefficient, k) can only be achieved with an increased etch rate, which corresponds to lower etch selectivity. Likewise, AHM films with a lower etch rate, which corresponds to higher etch selectivity, also tend to have a high tensile stress.

### SUMMARY

This section provides a general summary of the disclosure, and is not a comprehensive disclosure of its full scope or all of its features.

A method for depositing a film includes arranging a substrate in a plasma enhanced chemical vapor deposition chamber; depositing a first ashable hardmask (AHM) layer that is carbon-based on the substrate; and during the depositing of the first AHM layer, doping with at least one dopant selected from a group consisting of silicon, silane, boron, nitrogen, germanium, carbon, ammonia, and carbon dioxide. An atomic percentage of the at least one dopant is greater than or equal to 5% of the first AHM layer.

In other features, the first AHM layer includes amorphous carbon. The method further includes ashing the first AHM layer with a plasma etch ash chemistry. The plasma etch ash chemistry is fluorine-free. The plasma etch ash chemistry includes fluorine. The plasma etch ash chemistry includes oxygen and nitrogen. The plasma etch ash chemistry includes hydrogen, ammonia and nitrogen.

In other features, the substrate includes one of a dielectric layer, a poly layer or a conductive layer and a second AHM layer arranged on the dielectric layer. The first AHM layer is deposited on the second AHM layer of the substrate. The second AHM layer is undoped. The atomic percentage of the at least one dopant is greater than or equal to 5% and less than or equal to 70% of the first AHM layer and the second AHM layer. A thickness of the first AHM layer is greater than or equal to 10% and less than or equal to 90% of a combined thickness of the first AHM layer and the second AHM layer.

A method for depositing a film includes arranging a substrate in a plasma enhanced chemical vapor deposition chamber; depositing a layer on the substrate; depositing a first ashable hardmask (AHM) layer on the layer; depositing a second AHM layer that is carbon-based on the first AHM layer; during the depositing of the second AHM layer, doping with at least one dopant selected from a group consisting of silicon, silane, boron, nitrogen, germanium, carbon, ammonia, and carbon dioxide. An atomic percentage of the at least one dopant is greater than or equal to 5% of the first AHM layer and second AHM layer.

In other features, the layer includes one of a poly layer, a dielectric layer and a conductive layer. The first AHM layer and the second AHM layer include amorphous carbon. The method further includes ashing the first AHM layer with a first plasma etch ash chemistry. The first plasma etch ash chemistry is fluorine-free. The method further includes ashing the second AHM layer with a second plasma etch ash chemistry. The second plasma etch ash chemistry includes fluorine.

In other features, the first plasma etch ash chemistry includes a combination of one of oxygen and nitrogen, and hydrogen, ammonia and nitrogen. The atomic percentage of the at least one dopant is greater than or equal to 5% and less than or equal to 70% of the first AHM layer and the second AHM layer. A thickness of the first AHM layer is greater than or equal to 10% and less than or equal to 90% of a combined thickness of the first AHM layer and the second AHM layer.

A substrate processing system includes a plasma enhanced chemical vapor deposition (PECVD) chamber and a showerhead arranged in the chamber. A pedestal is arranged in the chamber to support a substrate. A controller comprises instructions for depositing a first ashable hardmask (AHM) layer that is carbon-based on the substrate; and during the depositing of the first AHM layer, doping with at least one dopant selected from a group consisting of silicon, silane, boron, nitrogen, germanium, carbon, ammonia, and carbon dioxide. An atomic percentage of the at least one dopant is greater than or equal to 5% of the first AHM layer.

In other features, the first AHM layer includes amorphous carbon. The controller further comprises instructions for ashing the first AHM layer with a plasma etch ash chemistry including fluorine. The controller further comprises instructions for ashing the first AHM layer with a plasma etch ash chemistry including fluorine and one of oxygen and nitrogen, and hydrogen, ammonia and nitrogen.

In other features, the substrate includes a dielectric layer and a second AHM layer arranged on the dielectric layer. The first AHM layer is deposited on the second AHM layer of the substrate. The second AHM layer is undoped. The atomic percentage of the at least one dopant is greater than or equal to 5% and less than or equal to 70% of the first AHM layer and the second AHM layer. A thickness of the first AHM layer is greater than or equal to 10% and less than or equal to 90% of a combined thickness of the first AHM layer and the second AHM layer.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

The present disclosure will become more fully understood from the detailed description and the accompanying drawings, wherein:

FIGS. 1A-1C illustrate substrates with one or more doped AHM layers according to the present disclosure;

FIG. 2 illustrates an example of a method for fabricating the substrate of FIG. 1A;

FIGS. 3A-3B illustrate substrates with one or more doped AHM layers according to the present disclosure;

FIG. 4 illustrates an example of a method for fabricating the substrate of FIG. 3A;

FIG. 5 is a graph illustrating AHM thickness as a function of strip process time for doped and undoped AHM layers;

FIGS. 6A-6F illustrate processing of a substrate with a doped AHM film;

FIG. 7 illustrates an example of a substrate processing chamber; and

FIG. 8 is a functional block diagram of a control system for a processing chamber.

### DESCRIPTION

The following description is merely illustrative in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical OR. It should be understood that steps within a method may be executed in different order without altering the principles of the present disclosure.

Ashable hardmask (AHM) films according to the present disclosure are created by doping of carbon with one or more dopants selected from a group consisting of silicon (Si), silane (SiH₄), boron (B), nitrogen (N), germanium (Ge), carbon (C), ammonia (NH₃), carbon dioxide (CO₂) and combinations thereof. Doping of the AHM films enables lower etch rates to be achieved. A lower etch rate translates into a higher etch selectivity.

The doped AHM films described herein also tend to have higher transparency and lower stress than conventional AHM films. The doped AHM films also retain their ability to be ashed and can be stripped easily with plasma etch ash chemistry including fluorine, as will be described further below. Furthermore, the doped AHM films have selectivity to typical plasma etch ash chemistry.

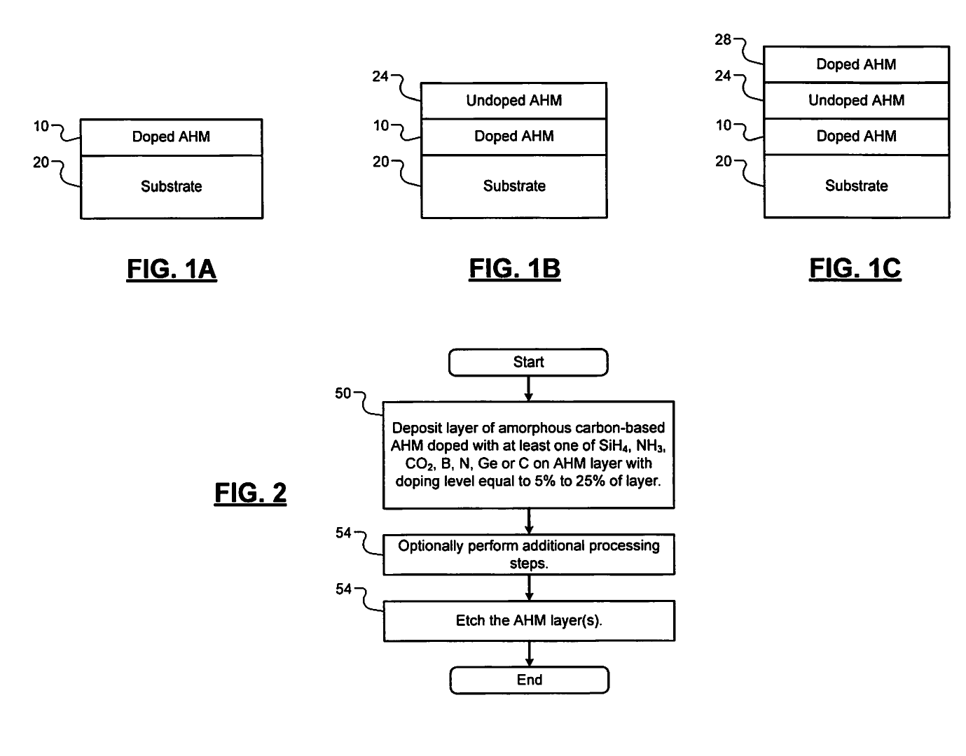

Referring now to FIGS. 1A-C and 2, examples of a substrate with one or more AHM layers is shown. In FIG. 1A, a doped AHM layer 10 is deposited onto a substrate 20. An outer layer of the substrate 20 may include a dielectric layer, a poly silicon (poly) layer, a conductive layer or other doped or undoped AHM layers. The doped AHM layer 10 may be deposited by a PECVD process, although other types of processes may be used.

One or more additional layers may be deposited. For example only, in FIG. 1B an undoped AHM layer 24 may be deposited on the doped AHM layer 10. The substrate has advantages in terms of known techniques to open the undoped AHM layer 24 using an antireflective layer (ARL) as a hard-mask and then ashing the doped AHM layer 10 using a fluorine-based plasma etch ash chemistry or another suitable chemistry.

Alternately in FIG. 1C, the undoped AHM layer 24 may be deposited on the doped AHM layer 10 and a doped AHM layer 28 may be deposited on the undoped AHM layer 24.

As can be appreciated, various other arrangements of layers are possible. For example, photoresist, antireflective layers, and other types of layers may also be used. Still other variations are contemplated.

In FIG. 2, an example of a method for depositing the AHM is illustrated. At 50, the doped AHM layer 10 is deposited on the substrate 20. An atomic percentage of the dopant is greater than or equal to 5%. In other examples, the atomic percentage of the dopant is greater than or equal to 6%, 7%, 8%, 9%, or 10%. In some examples, the atomic percentage of the dopant can be up to 25%, 50%, 70% or even higher. In some examples, the doping level may be controlled by a partial pressure of the dopant relative to other precursors supplied to the chamber. At 52, one or more optional processing steps are performed. At 54, the AHM layer is ashed using any suitable method.

In some examples, plasma etch ash chemistry that is fluorine free is used to ash the AHM layer. For example, the plasma etch ash chemistry may include oxygen and/or nitrogen. Alternately, the plasma etch ash chemistry may include hydrogen, ammonia and/or nitrogen. In other examples, the plasma etch ash chemistry further includes flourine. For example, fluorine may be added to a combination of oxygen and nitrogen or a combination of hydrogen, ammonia and nitrogen. For example, 1.7% CF₄ may be added to the plasma etch ash chemistries, although other precursors and/or concentrations may be used.

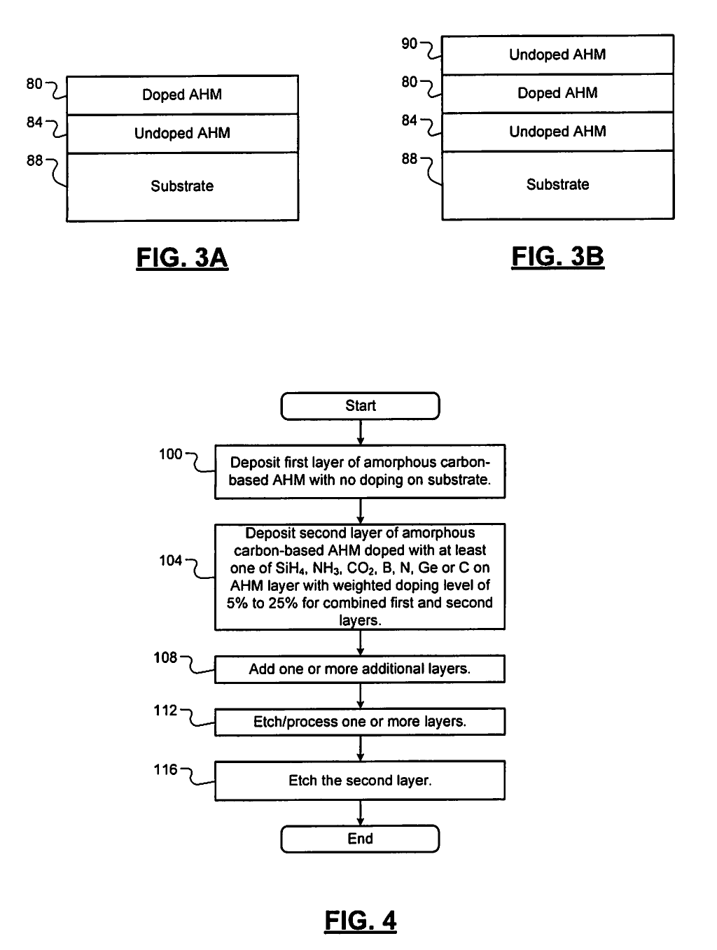

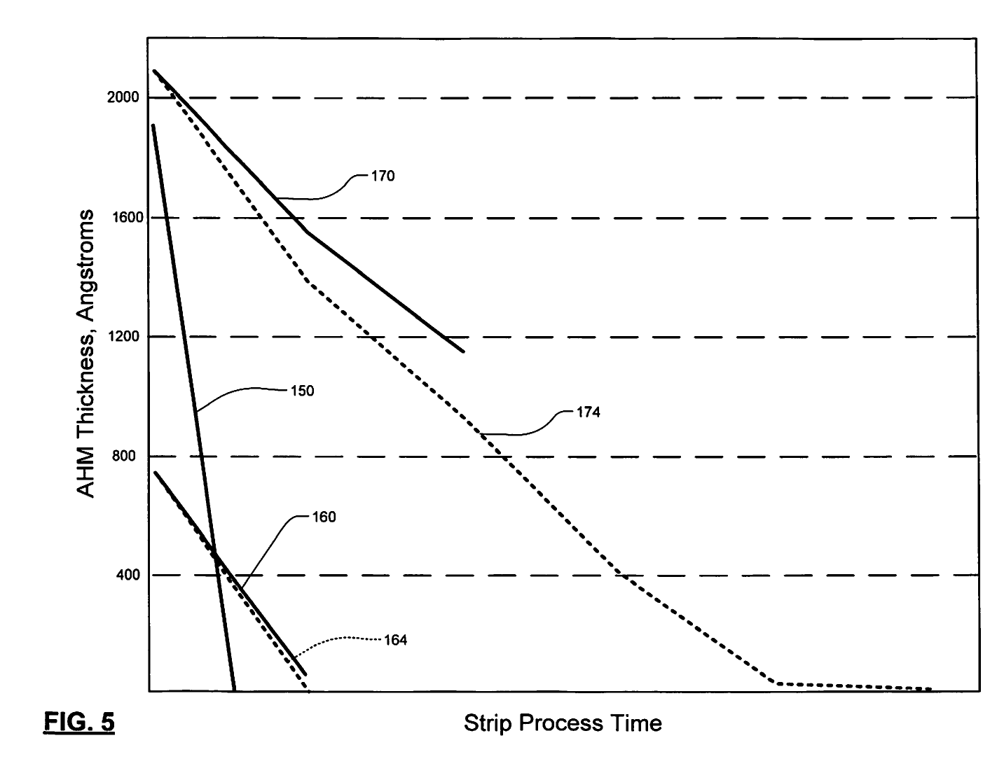

Referring now to FIGS. 3A-3B and 4, another example of doped AHM layer is shown. In FIG. 3A, a doped AHM layer 80 is deposited on another AHM layer 84 that is undoped or that has a low doping level. As used herein, the low doping level for an AHM film refers to less than 4% doping (where the specified % is the atomic percentage). The AHM film with less than 4% doping can usually be ashed completely or substantially using fluorine-free plasma etch ash chemistry. The undoped AHM layer 84 is deposited on a substrate 88. An outer layer of the substrate 88 may include a dielectric layer. The doped AHM layer 80 may be deposited by a PECVD process, although other processes may be used.

One or more additional layers may be deposited. For example only in FIG. 3B, an undoped AHM layer 90 may be deposited on the doped AHM layer 80.

As can be appreciated, various other arrangements of layers are possible. For example, photoresist, antireflective layers, and other types of layers may also be used. Still other variations are contemplated.

In FIG. 4, an example of a method for depositing the AHM layer is illustrated. At 100, a first AHM layer is deposited on the substrate. The first AHM layer has no doping or low doping. At 104, a second AHM layer is deposited. The second AHM layer is doped at a level greater than or equal to 5% (where the specified % is the atomic percentage). In other examples, the atomic percentage of the dopant is greater than or equal to 6%, 7%, 8%, 9%, or 10%. Alternately, the second AHM layer is doped at a level greater than or equal to 5% for the combined first and second layers. In some examples, the atomic percentage of the dopant can be up to 25%, 50%, 70% or even higher.

For example only, if the first layer has 0% doping and a first thickness equal to one half of a total thickness of the first and second layers, the second layer is doped greater than or equal to 10% and less than or equal to 50% to provide an overall doping of 5%-25% (where the specified % is the atomic percentage). When used in combination with an undoped or low doped AHM layer, the doped AHM layer may comprise 10%-90% of the total thickness and the undoped or low doped AHM layer may comprise 90%-10% of the total thickness. While a two layer structure is disclosed in some examples, additional layers may be used depending upon the application. For example, an undoped AHM layer may be sandwiched between two undoped AHM layers.

At 108, optionally one or more additional layers are deposited on the second layer. At 112, optionally one or more additional layers are etched. At 118, the second layer is etched. In some examples, a plasma etch ash chemistry that is fluorine free is used to ash the second layer. In other examples, a plasma etch ash chemistry including fluorine is used as will be described below.

In the foregoing section, typical operating parameters and recipes are set forth in Tables I, II and III. While specific examples are disclosed, other recipes and parameters may be used.

TABLE I

| | 4-Station Parameters | |
|---|---|---|
| | Typ. Param. | Units |
| C2H2 | 1000-9000 | Sccm |
| H2 | 1000-9000 | Sccm |
| He | 500-20000 | Sccm |
| Ar | 500-20000 | Sccm |
| B2H6 | 0-10000 | Sccm |
| N2 | 0-10000 | Sccm |
| Ge | 0-1000 | Sccm |
| SiH4 | 10-10000 | Sccm |
| Pressure | 0.5-7.5 | Torr |
| Temperature | 275-400 | C. |
| LFRF | 500-3000 | W |
| HFRF | 200-3000 | W |

TABLE II

| | | | | | Typ. | |
|---|---|---|---|---|---|---|
| | Typ. Param. | Units | Typ. Param. | Units | Param. | Units |
| C2H2 | 3000 | Sccm | 7000 | Sccm | 5000 | Sccm |
| H2 | 3000 | Sccm | 1500 | Sccm | 5000 | Sccm |
| He | 0 | Sccm | 2500 | Sccm | 3000 | Sccm |
| Ar | 1500 | Sccm | 0 | Sccm | 1500 | Sccm |
| B2H6 | 0 | Sccm | 300 | Sccm | 0 | Sccm |
| N2 | 0 | Sccm | 0 | Sccm | 500 | Sccm |
| SiH4 | 800 | Sccm | 900 | Sccm | 200 | Sccm |
| GeH4 | 0 | Sccm | 0 | Sccm | 0 | Sccm |
| Pressure | 0.9 | Torr | 1.2 | Torr | 1.8 | Torr |
| Temperature | 350 | C. | 350 | C. | 350 | C. |
| LFRF | 2400 | W | 2400 | W | 2400 | W |
| HFRF | 400 | W | 400 | W | 400 | W |

TABLE III

| | Typ. Param. | Units | Typ. Param. | Units |
|---|---|---|---|---|
| C2H2 | 5000 | Sccm | 5000 | Sccm |
| H2 | 5000 | Sccm | 5000 | Sccm |
| He | 3000 | Sccm | 3000 | Sccm |
| Ar | 1500 | Sccm | 1500 | Sccm |
| B2H6 | 0 | Sccm | 0 | Sccm |
| N2 | 500 | Sccm | 500 | Sccm |
| SiH4 | 200 | Sccm | 200 | Sccm |
| GeH4 | 1000 | Sccm | 3000 | Sccm |
| Pressure | 1.8 | Torr | 1.8 | Torr |
| Temperature | 350 | C. | 350 | C. |
| LFRF | 2400 | W | 2400 | W |
| HFRF | 400 | W | 400 | W |

Referring now to FIG. 5, solid lines represent examples of AHM films that can be ashed using fluorine free plasma etch ash chemistry. Dotted lines represent examples of AHM films that can be ashed with plasma etch ash chemistry with fluorine. Etching of an undoped AHM layer is shown at 150. As can be seen, the undoped AHM has a very high etch rate and a relatively low selectivity. Etching of a second doped AHM layer (doped with silicon) is shown at 160 using fluorine-free plasma etch ash chemistry and at 164 using plasma etch ash chemistry with fluorine. The film has a lower etch rate and higher selectivity. As can be seen, etching of the doped AHM layer using fluorine-free plasma etch ash chemistry at 160 does not result in complete stripping of the AHM layer (etching stopped at about 50-60 Angstroms). In contrast, etching of the AHM layer at 164 using plasma etch ash chemistry with fluorine results in far more of the AHM layer being stripped.

Etching of a third doped AHM layer (doped with silicon) is shown at 170 using fluorine-free plasma etch ash chemistry and at 174 using plasma etch ash chemistry with fluorine. The third doped film includes silane. As can be seen, etching of the doped AHM layer using fluorine-free plasma etch ash chemistry at 170 does not result in complete stripping of the AHM layer (etching stopped at about 1100-1200 Angstroms). In contrast, etching of the AHM layer at 174 using plasma etch ash chemistry with fluorine results in far more of the AHM layer being stripped. The third AHM layer also shows further improvement of the etching selectivity.

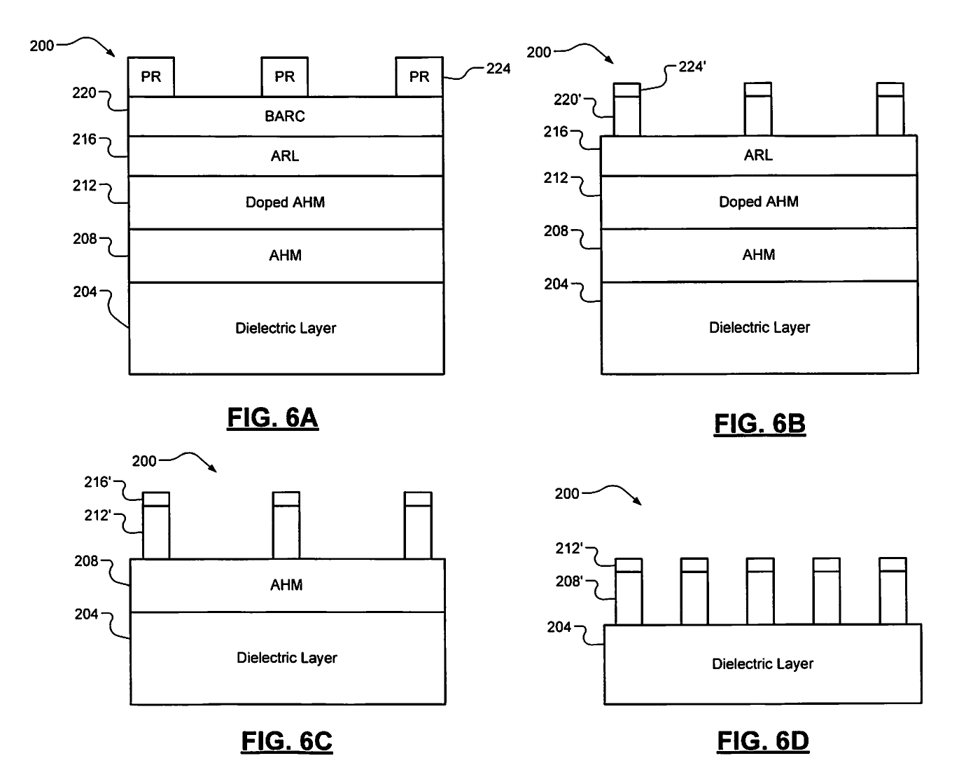

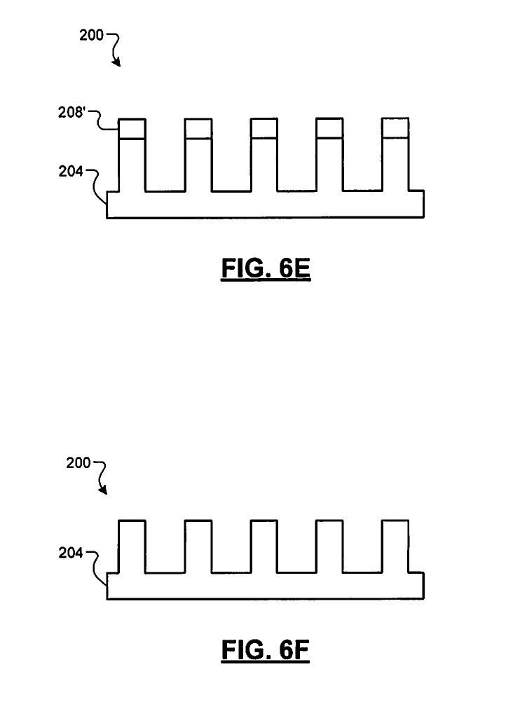

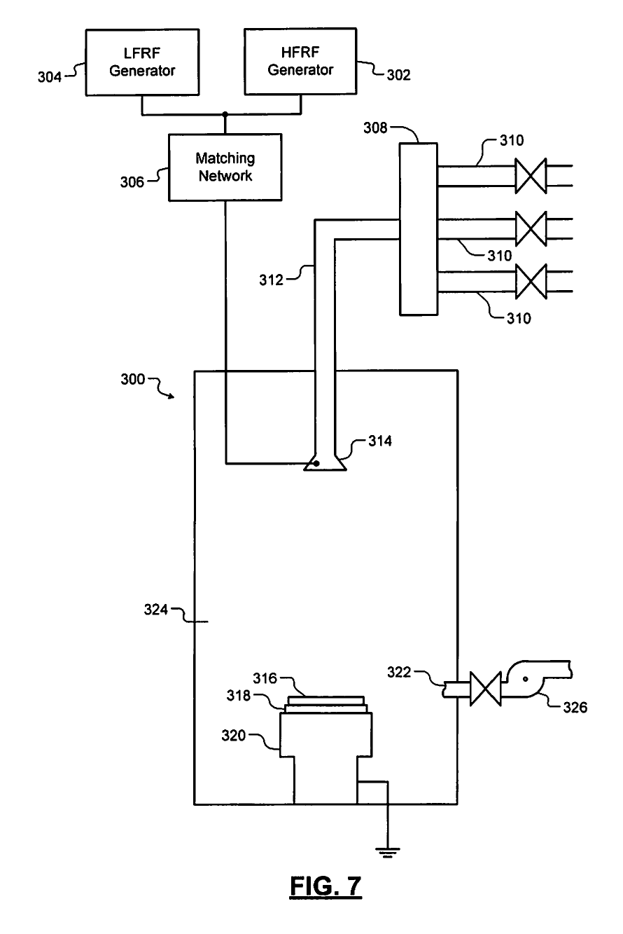

Referring now to FIGS. 6A-6F, an example of an etching process for a dielectric layer 204 of a substrate 200 is shown. In FIG. 6A, a first AHM layer 208 with no doping or low doping is deposited on the dielectric layer 204. A second AHM layer 212 with doping described herein is deposited on the first AHM layer 208. An antireflective layer (ARL) 216 is deposited on the second AHM layer 212. A bottom antireflective coating (BARC) layer 220 is deposited on the ARL 216. A photoresist layer 224 is deposited on the BARC layer 220. In FIGS. 6B-6C, the substrate is shown after one or more processing steps such as photolithography patterning and open etch. In FIG. 6D, patterned portions of the AHM layer 212′ and the film layer 206′ remain.

The doped AHM layer 212′ acts as a secondary masking material for etching the dielectric layer 204. The remaining doped AHM layer 212′ provides high etch selectivity relative to the dielectric layer 204. The doped AHM layer 212 also has a low extinction coefficient and stress. The doped AHM layer 212 is also removed during the dielectric etching process without the need for chemical mechanical polishing. In FIGS. 6E-6F, etching of the dielectric layer 204 is completed and the first AHM layer 208′ is fully stripped. As can be appreciated, the use of the doped AHM layer allows etching of deeper features that photoresist would generally allow.

Referring now to FIG. 7, the doped ashable hardmask film may be deposited in any suitable substrate processing chamber. For example only, a reactor 300 is shown in FIG. 7. The reactor 300 performs plasma enhanced chemical vapor deposition (PECVD). The PECVD system may take many different forms. The PECVD system typically includes one or more chambers or “reactors” (sometimes including multiple stations) that house one or more substrates and are suitable for substrate processing. Each chamber may house one or more substrates for processing. In some examples, the substrate can be a semiconductor wafer.

The one or more chambers maintain the substrate in a defined position or positions (with or without motion within that position, e.g. rotation, vibration, or other agitation). A substrate undergoing deposition may be transferred from one station to another within a reactor chamber during the process. The film deposition may occur entirely at a single station or any fraction of the film may be deposited at any number of stations. While in process, each substrate is held in place by a pedestal, substrate chuck and/or other substrate holding apparatus. For certain operations, the apparatus may include a heater such as a heating plate to heat the substrate.

For example, the reactor 300 in FIG. 7 includes a process chamber 324, which encloses other components of the reactor and contains the plasma. The plasma may be generated by a capacitor type system including a showerhead 314 working in conjunction with a grounded heater block 320. A high-frequency RF generator 302, connected to a matching network 306, and a low-frequency RF generator 304 are connected to the showerhead 314. The power and frequency supplied by matching network 306 is sufficient to generate plasma from the process gas.

Within the reactor, a substrate pedestal 318 supports a substrate 316. The pedestal 318 typically includes a chuck, a fork, or lift pins to hold and transfer the substrate during and between the deposition and/or plasma treatment reactions. The chuck may be an electrostatic chuck, a mechanical chuck or various other types of chuck.

The process gases are introduced via inlet 312. Multiple source gas lines 310 are connected to manifold 308. The gases may be premixed or not. Appropriate valving and mass flow control mechanisms are employed to ensure that the correct gases are delivered during the deposition and plasma treatment phases of the process.

Process gases exit chamber 324 via an outlet 322. A vacuum pump 326 (e.g., a one or two stage mechanical dry pump and/or a turbomolecular pump) draws process gases out and maintains a suitably low pressure within the reactor by a close loop controlled flow restriction device, such as a throttle valve or a pendulum valve.

It is possible to index the substrates after every deposition and/or post-deposition plasma anneal treatment until all the required depositions and treatments are completed, or multiple depositions and treatments can be conducted at a single station before indexing the substrate.

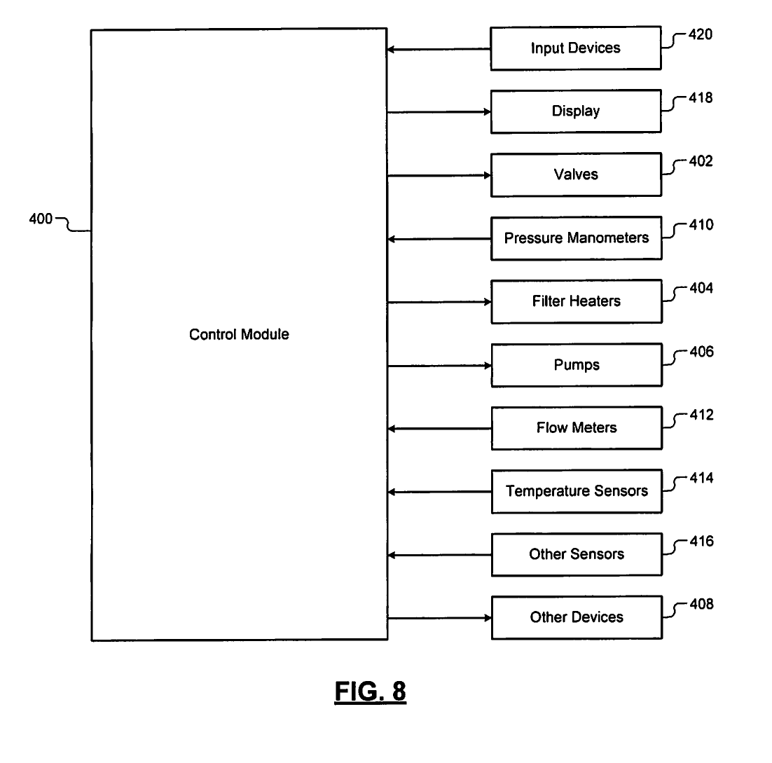

Referring now to FIG. 8, a control module 400 for controlling the systems of FIG. 7 is shown. The control module 400 may include a processor, memory and one or more interfaces. The control module 400 may be employed to control devices in the system based in part on sensed values. For example only, the control module 400 may control one or more of valves 402, filter heaters 404, pumps 406, and other devices 408 based on the sensed values and other control parameters. The control module 400 receives the sensed values from, for example only, pressure manometers 410, flow meters 412, temperature sensors 414, and/or other sensors 416. The control module 400 may also be employed to control process conditions during precursor delivery and deposition of the film. The control module 400 will typically include one or more memory devices and one or more processors.

The control module 400 may control activities of the precursor delivery system and deposition apparatus. The control module 400 executes computer programs including sets of instructions for controlling process timing, delivery system temperature, pressure differentials across the filters, valve positions, mixture of gases, chamber pressure, chamber temperature, substrate temperature, RF power levels, substrate chuck or pedestal position, and other parameters of a particular process. The control module 400 may also monitor the pressure differential and automatically switch vapor precursor delivery from one or more paths to one or more other paths. Other computer programs stored on memory devices associated with the control module 400 may be employed in some embodiments.

Typically there will be a user interface associated with the control module 400. The user interface may include a display 418 (e.g. a display screen and/or graphical software displays of the apparatus and/or process conditions), and user input devices 420 such as pointing devices, keyboards, touch screens, microphones, etc.

Computer programs for controlling delivery of precursor, deposition and other processes in a process sequence can be written in any conventional computer readable programming language. Compiled object code or script is executed by the processor to perform the tasks identified in the program.

The control module parameters relate to process conditions such as, for example, filter pressure differentials, process gas composition and flow rates, temperature, pressure, plasma conditions such as RF power levels and the low frequency RF frequency, cooling gas pressure, and chamber wall temperature.

The system software may be designed or configured in many different ways. For example, various chamber component subroutines or control objects may be written to control operation of the chamber components necessary to carry out the inventive deposition processes. Examples of programs or sections of programs for this purpose include substrate positioning code, process gas control code, pressure control code, heater control code, and plasma control code.

A substrate positioning program may include program code for controlling chamber components that are used to load the substrate onto a pedestal or chuck and to control the spacing between the substrate and other parts of the chamber such as a gas inlet and/or target. A process gas control program may include code for controlling gas composition and flow rates and optionally for flowing gas into the chamber prior to deposition in order to stabilize the pressure in the chamber. A filter monitoring program includes code comparing the measured differential(s) to predetermined value(s) and/or code for switching paths. A pressure control program may include code for controlling the pressure in the chamber by regulating, e.g., a throttle valve in the exhaust system of the chamber. A heater control program may include code for controlling the current to heating units for heating components in the precursor delivery system, the substrate and/or other portions of the system. Alternatively, the heater control program may control delivery of a heat transfer gas such as helium to the substrate chuck.

Examples of sensors that may be monitored during deposition include, but are not limited to, mass flow control modules, pressure sensors such as the pressure manometers 410, and thermocouples located in delivery system, the pedestal or chuck (e.g. the temperature sensors 414). Appropriately programmed feedback and control algorithms may be used with data from these sensors to maintain desired process conditions. The foregoing describes implementation of embodiments of the invention in a single or multi-chamber semiconductor processing tool.

The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A method for depositing a film, comprising:
arranging a substrate in a plasma enhanced chemical vapor deposition chamber;
depositing a first ashable hardmask (AHM) layer that is carbon-based on the substrate; and
during the depositing of the first AHM layer, doping with at least one dopant selected from a group consisting of silicon, silane, boron, nitrogen, germanium, carbon, ammonia, and carbon dioxide,
wherein an atomic percentage of the at least one dopant is greater than or equal to 5% of the first AHM layer.

2. The method of claim 1, wherein the first AHM layer includes amorphous carbon.

3. The method of claim 1, further comprising ashing the first AHM layer with a plasma etch ash chemistry.

4. The method of claim 3, wherein the plasma etch ash chemistry is fluorine-free.

5. The method of claim 3, wherein the plasma etch ash chemistry includes fluorine.

6. The method of claim 3, wherein the plasma etch ash chemistry includes oxygen and nitrogen.

7. The method of claim 3, wherein the plasma etch ash chemistry includes hydrogen, ammonia and nitrogen.

8. The method of claim 1, wherein the substrate includes:
a layer comprising one of a dielectric layer, a poly layer and a conductive layer; and
a second AHM layer arranged on the layer.

9. The method of claim 8, wherein the first AHM layer is deposited on the second AHM layer of the substrate.

10. The method of claim 8, wherein the second AHM layer is undoped.

11. The method of claim 8, wherein the atomic percentage of the at least one dopant is greater than or equal to 5% and less than or equal to 70% of the first AHM layer and the second AHM layer.

12. The method of claim 8, wherein a thickness of the first AHM layer is greater than or equal to 10% and less than or equal to 90% of a combined thickness of the first AHM layer and the second AHM layer.

13. The method of claim 1, further comprising:
depositing a second AHM layer on the first AHM layer, wherein the second AHM layer is undoped.

14. The method of claim 13, further comprising:
depositing a third AHM layer on the second AHM layer, wherein the third AHM layer is doped with at least one dopant selected from a group consisting of silicon, silane, boron, nitrogen, germanium, carbon, ammonia, and carbon dioxide, and wherein an atomic percentage of the at least one dopant is greater than or equal to 5% of the first AHM layer.

15. A method for depositing a film, comprising:
arranging a substrate in a plasma enhanced chemical vapor deposition chamber;
depositing a layer on the substrate;
depositing a first ashable hardmask (AHM) layer on the layer;
depositing a second AHM layer that is carbon-based on the first AHM layer; and
during the depositing of the second AHM layer, doping with at least one dopant selected from a group consisting of silicon, silane, boron, nitrogen, germanium, carbon, ammonia, and carbon dioxide,
wherein an atomic percentage of the at least one dopant is greater than or equal to 5% of the first AHM layer and second AHM layer.

16. The method of claim 15, wherein the layer comprises one of a poly layer, a dielectric layer and a conductive layer.

17. The method of claim 16, wherein the first AHM layer and the second AHM layer include amorphous carbon.

18. The method of claim 15, further comprising:
ashing the first AHM layer with a first plasma etch ash chemistry, wherein the first plasma etch ash chemistry is fluorine-free; and
ashing the second AHM layer with a second plasma etch ash chemistry, wherein the second plasma etch ash chemistry includes fluorine.

19. The method of claim 18, wherein the first plasma etch ash chemistry includes a combination of one of:
oxygen and nitrogen; and
hydrogen, ammonia and nitrogen.

20. The method of claim 15, wherein the atomic percentage of the at least one dopant is greater than or equal to 5% and less than or equal to 70% of the first AHM layer and the second AHM layer.

21. The method of claim 15, wherein a thickness of the first AHM layer is greater than or equal to 10% and less than or equal to 90% of a combined thickness of the first AHM layer and the second AHM layer.

22. The method of claim 15, further comprising depositing a third AHM layer on the second AHM layer, wherein the third AHM layer is undoped.

23. A substrate processing system, comprising:
a plasma enhanced chemical vapor deposition (PECVD) chamber;
a showerhead arranged in the chamber;
a pedestal arranged in the chamber to support a substrate;
a controller comprising instructions for:
depositing a first ashable hardmask (AHM) layer on the substrate; and
during the depositing of the first AHM layer, doping with at least one dopant selected from a group consisting of silicon, silane, boron, nitrogen, germanium, carbon, ammonia, and carbon dioxide,
wherein an atomic percentage of the at least one dopant is greater than or equal to 5% of the first AHM layer.

24. The substrate processing system of claim 23, wherein the first AHM layer includes amorphous carbon.

25. The substrate processing system of claim 23, wherein the controller further comprises instructions for ashing the first AHM layer with a plasma etch ash chemistry including fluorine.

26. The substrate processing system of claim 23, wherein the controller further comprises instructions for ashing the first AHM layer with a plasma etch ash chemistry including fluorine and one of:
oxygen and nitrogen; and
hydrogen, ammonia and nitrogen.

27. The substrate processing system of claim 23, wherein the substrate includes:
a layer; and
a second AHM layer arranged on the layer.

28. The substrate processing system of claim 27, wherein the layer includes one of a dielectric layer, a poly layer and a conductive layer.

29. The substrate processing system of claim 27, wherein the first AHM layer is deposited on the second AHM layer of the substrate.

30. The substrate processing system of claim 27, wherein the second AHM layer is undoped.

31. The substrate processing system of claim 27, wherein the atomic percentage of the at least one dopant is greater than or equal to 5% and less than or equal to 25% of the first AHM layer and the second AHM layer.

32. The substrate processing system of claim 27, wherein a thickness of the first AHM layer is greater than or equal to 10% and less than or equal to 90% of a combined thickness of the first AHM layer and the second AHM layer.
